(19) United States
(12) Patent Application Publication
(10) Pub. No.: US 2024/0416460 A1
(43) Pub. Date: Dec. 19, 2024

(54) PROTECTIVE METHOD AND SYSTEM COMBINING PROCESS MONITORING AND CONTROL IN LASER DRILLING

(71) Applicant: XI'AN JIAOTONG UNIVERSITY, Xi'an (CN)

(72) Inventors: Xuesong MEI, Xi'an (CN); Tao SUN, Xi'an (CN); Wanqin ZHAO, Xi'an (CN); Zhengjie FAN, Xi'an (CN); Jianlei CUI, Xi'an (CN); Wenjun WANG, Xi'an (CN); Bin LIU, Xi'an (CN); Wenqiang DUAN, Xi'an (CN); Xiaodong WANG, Xi'an (CN); Aifei PAN, Xi'an (CN)

(73) Assignee: XI'AN JIAOTONG UNIVERSITY, Xi'an (CN)

(21) Appl. No.: 18/820,152

(22) Filed: Aug. 29, 2024

Related U.S. Application Data
(63) Continuation of application No. PCT/CN2023/135233, filed on Nov. 29, 2023.

(30) Foreign Application Priority Data
May 29, 2023 (CN) 2023106193045

(51) Int. Cl. B23K 26/382; B23K 26/046

(52) U.S. Cl. CPC B23K 26/382; B23K 26/046

(57) ABSTRACT

The present disclosure provides a protective method and system combining process monitoring and control in laser drilling. This method includes collecting signal evolution information, a current hole depth, and motion track information in a laser drilling process; performing a feature extraction on the signal to obtain sequential eigenvalues evolving over time, and constructing a prediction model of the penetration time based on the eigenvalues; combining the hole depth and motion track information with the eigenvalues to construct a drilling stage identification model; combining a prediction result of the prediction model of penetration time and identification confidence of the identification model at different moments to construct a state identification model; and judging a current drilling stage according to the model, controlling the processing process according to a judgment result, and using different drilling strategies at different drilling stages. High-efficiency, high-accuracy, and wall-damage-free processing can be ensured.

### CROSS-REFERENCE TO RELATED APPLICATIONS

The application claims priority to Chinese patent application No. 2023106193045, filed on May 29, 2023, the entire contents of which are incorporated herein by reference.

### TECHNICAL FIELD

The present disclosure belongs to the field of laser processing and manufacturing, and particularly relates to a protective method and system combining process monitoring and control in the laser drilling.

### BACKGROUND

Laser processing has various characteristics such as high processing accuracy, high processing quality, ability to process almost any material, and contactless processing. In laser processing, due to its contactless processing and Gaussian light transmission characteristics, a processing depth cannot be controlled by axial feed, and a laser in a range near a focus will still cause damage to a material. At the same time, light transmission of a laser processing process is prone to the interference of structural evolution, plasma eruption and other phenomena of the processing process, leading to fluctuations in the processing process and problems with processing repeatability and stability. As a result, when these workpieces with hollow cavities (a blade, an oil nozzle, etc.) are processed, there is often an over-ablation problem, resulting in deterioration in a processing quality or a reduction in a service life of the workpieces, which is intolerable in most cases.

At present, methods to solve the over-ablation problem are mainly divided into two kinds: filling materials in the cavity and process monitoring. The first method is to fill a hollow cavity with some materials that can be used for weakening or even eliminating an effect of laser ablation. Process monitoring is to monitor a drilling state in real time, and control the processing process according to different drilling states. However, the protection state cannot be fed back when filling materials in the cavity, and it is difficult to realize the protection of a narrow cavity. A link between a signal obtained from the current processing process monitoring and the processing process is often indirect, and it is difficult to realize an accurate control of the processing process, which seriously hinders the application of laser processing to the workpieces with hollow cavities, and restricts the development of a laser processing technology.

### SUMMARY

An objective of the present disclosure is to provide a protective method and system combining process monitoring and control in laser drilling, which overcomes a defect of a poor processing quality existing in existing laser processing.

To achieve the above objective, a technical solution adopted by the present disclosure is as follows.

A protective method combining process monitoring and control in laser drilling provided by the present disclosure includes the following steps:
step 1, collecting signal evolution information, a current hole depth, and motion track information in a laser drilling processing process;
step 2, performing a feature extraction on the signal evolution information obtained in step 1 to obtain sequential eigenvalues evolving over time, and constructing a prediction model of penetration time according to the obtained sequential eigenvalues;
step 3, combining the current hole depth and the motion track information obtained in step 1 with the sequential eigenvalues to construct and obtain a drilling stage identification model;
step 4, synthesizing a prediction result of the prediction model of penetration time and combining identification result confidence of the drilling stage identification model at different moments to construct and obtain a state identification model; and
step 5, judging a current drilling processing stage according to the obtained state identification model, controlling the laser processing process according to a judgment result, and using different drilling strategies at different drilling stages.

Preferably, in step 2, a specific method for constructing the prediction model of penetration time according to the obtained sequential eigenvalues is:
setting the drilling processing process in four stages, which are an unpenetrated stage, an early penetration stage, a hole forming stage, and a hole completion stage respectively;
obtaining remaining drilling penetration time values corresponding to sequential eigenvalues at different moments according to an evolution process of the set unpenetrated stage and early penetration stage; and
combining the obtained sequential eigenvalues with a laser parameter and a material parameter as training features, and using the remaining drilling penetration time values as training labels to construct and obtain the prediction model of penetration time by using an autoregressive deep learning method.

Preferably, in step 3, a specific method for combining the current hole depth and the motion track information obtained in step 1 with the sequential eigenvalues to construct and obtain the drilling stage identification model is:
fusing the current hole depth and the motion track information obtained in step 1 to obtain depth information of a specific point on a drilling track;
forming three-dimensional point cloud information according to the obtained depth information;
filtering, segmenting and fitting the obtained three-dimensional point cloud information sequentially to obtain a three-dimensional point cloud model of a hole;
performing a feature extraction on the three-dimensional point cloud model of the hole to obtain shape features such as outlet and inlet diameters of the hole; and
combining depth features, the shape features and the sequential eigenvalues of the hole, and using the depth features and shape features of the hole corresponding to calibrated different drilling stages as labels to construct and obtain the drilling stage identification model by using a machine learning method.

Preferably, in step 4, a specific combination method for constructing and obtaining the state identification model according to a combination of the prediction model of penetration time and the drilling stage identification model is:
inputting the sequential eigenvalues and shape features corresponding to different moments into the drilling stage identification model established in step 3 so as to obtain the identification result confidence of drilling stages at different moments in real time;
inputting the sequential eigenvalues corresponding to different moments into the prediction model of penetration time established in step 2 so as to predict remaining penetration time corresponding to a current moment in real time;
weighing and fusing the identification result confidence of the drilling stages at different moments to obtain synthesized confidence at the current moment; and
performing a probability fusion on the predicted remaining penetration time at the current moment with the synthesized confidence to obtain the state identification model.

Preferably, in step 5, the different drilling strategies are specifically:
adjusting a processing parameter with processing efficiency as a target when the current hole processing stage is an unpenetrated stage;
adjusting a light field distribution of laser processing with a hole depth control as a target when the current hole processing stage is an early penetration stage and a hole forming stage; and
stopping processing when the drilling stage switches from the hole forming stage to a hole completion stage.

Preferably, a specific method for adjusting the processing parameter with the processing efficiency as the target when the current hole processing stage is the unpenetrated stage is:
using a current drilling depth, laser power and a focus position as inputs, and an actual ablation rate change as an output; and establishing a correlation model between the ablation rate change and the current drilling depth, the laser power and the focus position by using a neural network, and adjusting the processing parameter by using the correlation model.

Preferably, a specific method for adjusting the light field distribution of laser processing with the hole depth control as the target when the current hole processing stage is the early penetration stage and the hole forming stage is:
locating processing point coordinates through coaxial vision, and switching a Gaussian processing light path to a beam shaping light path;
shaping a Gaussian beam into an axial-ablation-limited Bessel beam by using a beam shaping device; and
trimming a hole by using the shaped beam.

A protective system combining process monitoring and control in laser drilling includes a laser, a beam transmission system, a dichroic mirrors, a sensing system, a beam switching system, a beam shaping system, a focusing lens, and a scanning galvanometer, wherein a laser beam output by the laser passes through the beam transmission system and is then incident through the dichroic mirrors to the beam switching system; an output light path of the beam switching system is divided into two paths, one of which passes through the beam shaping system and is then incident to the focusing lens for focusing, and the other is incident to the scanning galvanometer for focusing; and laser beams output by the focusing lens and the scanning galvanometer act on a target material.

Preferably, the beam shaping system includes a beam shaping element and a 4f system, wherein the output light path of the beam switching system passes through the beam shaping element and is incident to the 4f system to form Bessel light.

Compared with the prior art, the present disclosure has the beneficial effects:

In the protective method combining process monitoring and control in the laser drilling provided by the present disclosure, the drilling process is divided into the four stages, and the state identification model for identifying different drilling stages is established by extracting differences in signal distributions of the processing process and by the reconstruction and feature extraction of a three-dimensional shape of the hole. According to different drilling stages, different drilling strategies are used. Through an adjustment of a longitudinal energy distribution of the Gaussian beam, combined with visual locating, accurate switching of the drilling light path and the trimming light path is completed, and thus high efficiency, high accuracy, and wall-damage-free processing of the laser drilling process are ensured.

In the protective system combining process monitoring and control in the laser drilling provided by the present disclosure, through a combination of the dichroic mirrors and a beam splitter, coaxial coupling of a plurality of sensors and the processing light path is realized, the laser drilling process is monitored in real time, and the laser drilling stage is judged in real time. The longitudinal energy distribution of the Gaussian light is adjusted by using the optical shaping element, and thus a laser ablation depth is controlled in a certain focal depth range to ensure wall-damage-free processing. Combined with a visual locating technology, accurate switching of the Gaussian beam drilling light path and the beam shaping trimming light path is realized to meet the different drilling strategies required at different drilling stages, and thus high efficiency, high accuracy, and wall-damage-free processing of the laser drilling process are ensured.

### BRIEF DESCRIPTION OF DRAWINGS

FIG. 1 is a general flowchart of a method of the present disclosure.

FIG. 2 is a flowchart of a method of obtaining laser drilling depth information of the present disclosure.

FIG. 3 is a schematic diagram of division and calibration of drilling stages of the present disclosure.

FIG. 4 is a flowchart of establishing a state identification model of the present disclosure.

FIG. 5 is a flowchart of a method for a three-dimensional shape and feature extraction of a hole of the present disclosure.

FIG. 6 is a flowchart of a drilling strategy method of the present disclosure.

FIG. 7 is a flowchart of a visual locating method of the present disclosure.

FIG. 8 is a general schematic diagram of a system of the present disclosure.

FIG. 9 is a schematic diagram of a sensing system of the present disclosure.

FIG. 10 is a schematic diagram of an interferometric measurement system of the present disclosure.

FIG. 11 is a schematic diagram of a beam shaping system of the present disclosure.

### DETAILED DESCRIPTION OF THE EMBODIMENTS

The present disclosure is further illustrated in detail below in conjunction with accompanying drawings.

An objective of the present disclosure is to provide a protective method and system combining process monitoring and control in laser drilling, realizing high efficiency, high quality, and wall-damage-free processing in a laser drilling process, enhancing the controllability in the laser processing process, and promoting the application of a laser processing technology in the field of hollow-cavity material processing.

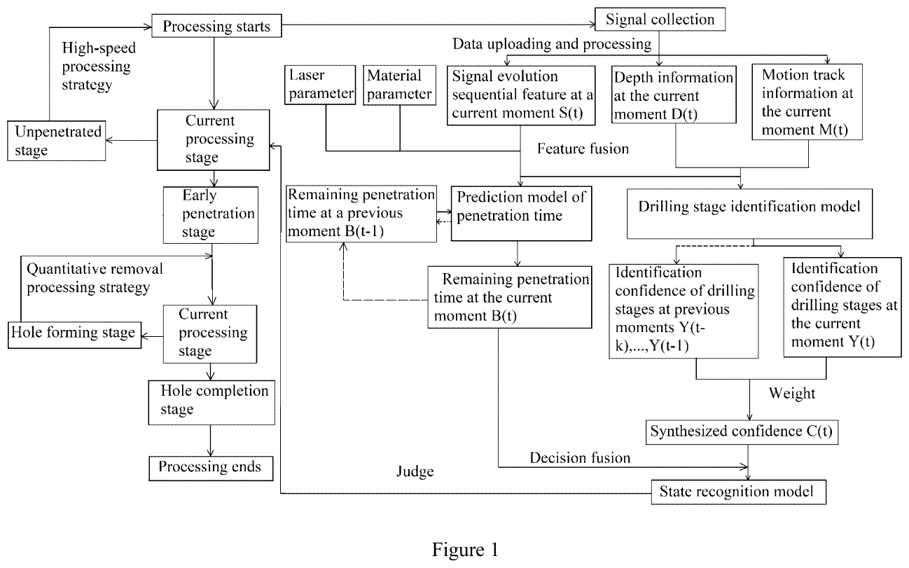

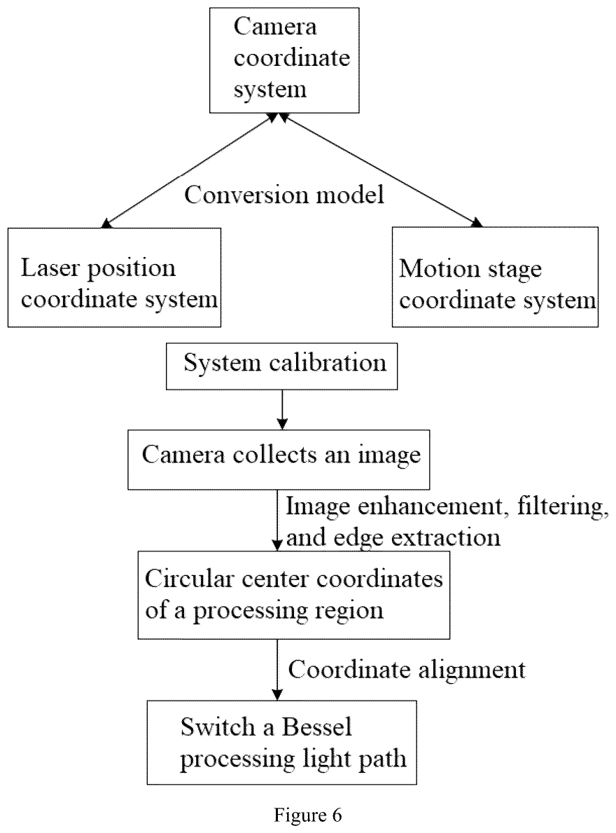

As shown in FIG. 1 to FIG. 6, a protective method combining process monitoring and control in laser drilling provided by the present disclosure contains the following steps.

Step 1, historical data of a target material in a laser drilling processing process is collected by using a sensing system, the historical data including signal evolution information, a current hole depth, and motion track information.

Step 2, the drilling processing process is set in four stages, which are an unpenetrated stage, an early penetration stage, a hole forming stage, and a hole completion stage respectively.

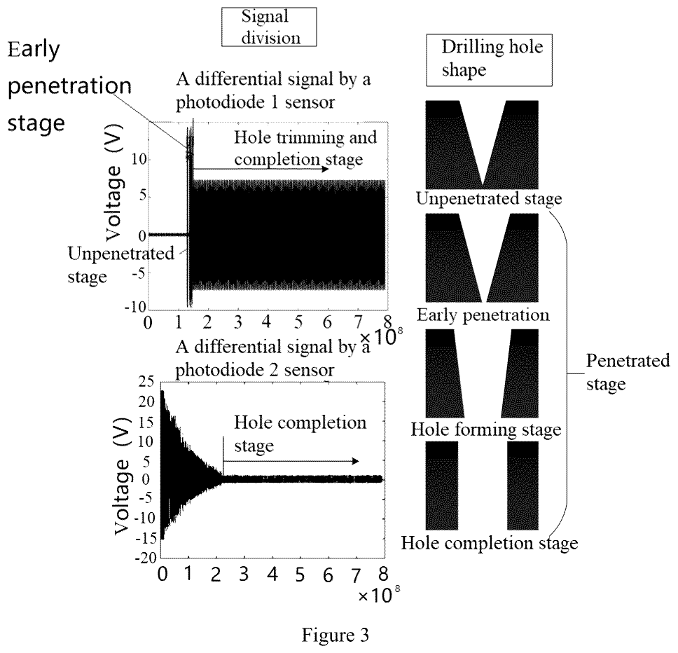

As shown in FIG. 3, a setting method performs calibration based on a photodiode sensor signal and a drilling hole shape, and a specific calibration method is as follows.

When a workpiece is not penetrated by a laser, the laser cannot be emitted from the back of the workpiece at this time, and an amplitude difference of a photodiode signal is in a lowest state, which is regarded as the unpenetrated stage.

When the workpiece is just penetrated by the laser, an outlet of the workpiece is very small at this time, only a small part of the laser is emitted from the back of the workpiece, and the amplitude difference of the photodiode signal is in a highest state, which is regarded as the early penetration stage.

After the workpiece is penetrated by the laser for a period of time, the outlet of the workpiece becomes larger at this time, the laser is stably emitted from the back of the workpiece, and the amplitude difference of the photodiode signal is in a stable change state, which is regarded as the hole forming stage.

After the workpiece is penetrated by the laser for a period of time, the outlet of the workpiece is almost unchanged, the laser has almost no ablation effect on the workpiece, and an amplitude of the photodiode signal is in a stable state, which is regarded as the hole completion stage.

A feature extraction is performed on the signal evolution information obtained in step 1 to obtain sequential eigenvalues evolving over time. Remaining drilling penetration time values corresponding to the sequential eigenvalues at different moments are obtained according to an evolution process of the set unpenetrated stage and early penetration stage. The obtained sequential eigenvalues are combined with laser parameters and material parameters as training features, and the remaining drilling penetration time values are used as training labels to construct and obtain a prediction model of penetration time by using an autoregressive deep learning method.

The sequential eigenvalues include a mean, a peak, a variance, etc.

The laser parameters include laser power, a repeated frequency, etc.

The material parameters include light absorptivity, thermal conductivity, a thickness, etc. corresponding to a current material.

The prediction model of penetration time constantly combines the collected data to predict remaining drilling penetration time at a current moment.

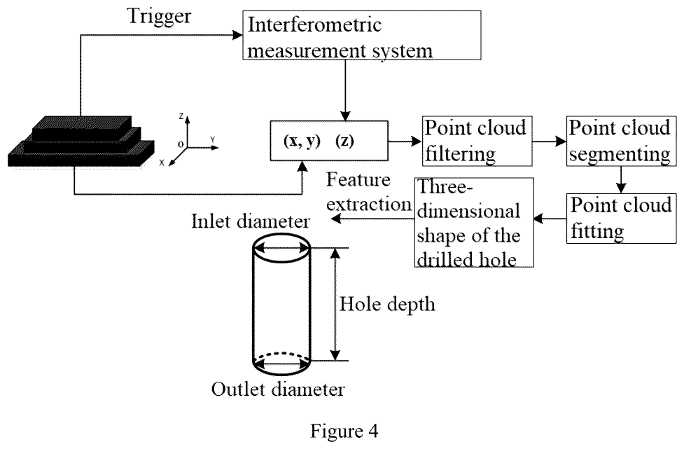

As shown in FIG. 4, the current hole depth (Z-axis information) and the motion track information (XY plane information) obtained in step 1 are fused to obtain depth information of a specific point on a drilling track, thus forming three-dimensional point cloud (X, Y, Z) information. The obtained three-dimensional point cloud information is filtered, segmented and fitted sequentially to establish and obtain a three-dimensional point cloud model of a hole.

Based on the three-dimensional point cloud model, depth features and shape features of the hole are extracted and obtained, and the shape features include outlet and inlet diameters, etc.

The obtained depth features and shape features of the hole are combined with the sequential eigenvalues, the depth features and shape features of the hole corresponding to the calibrated different drilling stages are used as labels, and a drilling stage identification model is established and obtained by using a machine learning method so as to realize the identification of the unpenetrated stage, the early penetration stage, the hole forming stage, and the hole completion stage according to signal features collected in the processing process.

According to the historical data corresponding to different moments obtained in step 1, the sequential eigenvalues and the shape features corresponding to different moments are obtained. The sequential eigenvalues and the shape features corresponding to different moments are input into the drilling stage identification model established in step 3 so as to obtain identification result confidence of drilling stages at different moments in real time.

The sequential eigenvalues corresponding to different moments are input into the prediction model of penetration time established in step 2 so as to predict remaining penetration time corresponding to the current moment in real time.

The identification result confidence of the drilling stages at different moments are weighed and fused to obtain synthesized confidence at the current moment.

A probability fusion is performed on the obtained synthesized confidence and predicted drilling remaining penetration time output by the prediction model of penetration time to establish and obtain a state identification model.

Step 3, laser processing parameters are set, and drilling processing is performed on the target material. Parameters of a current processing stage are obtained, and the relevant parameters are input into the state identification model constructed in step 2 to judge the current drilling processing stage in real time. The laser processing process is controlled according to a judgment result, and different drilling strategies are used at different drilling stages.

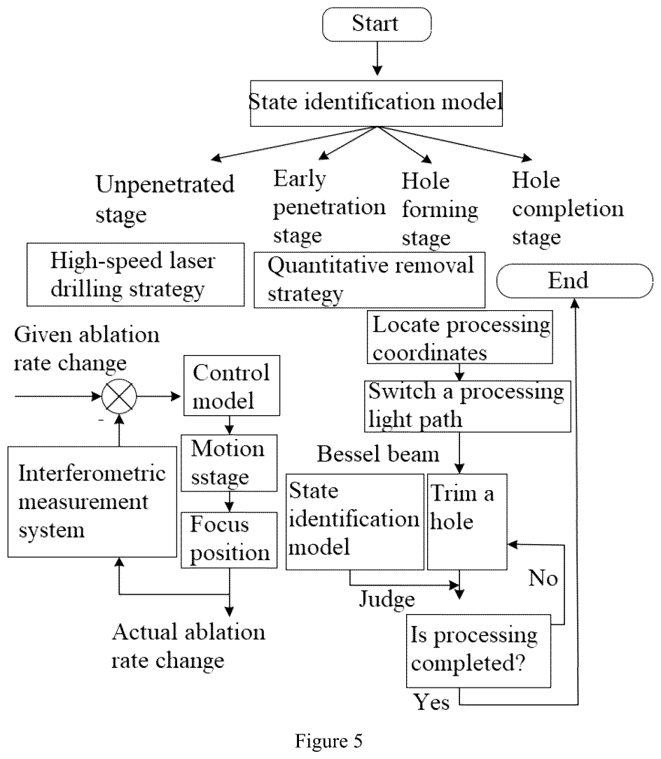

As shown in FIG. 5, a specific method for adjusting a processing parameter with processing efficiency as a target by using a high-speed processing strategy when the current hole processing stage is the unpenetrated stage is as follows.

A current drilling depth, laser power and a focus position are used as inputs, an actual ablation rate change is used as an output, and a correlation model between the ablation rate change and the current drilling depth, the laser power and the focus position is established by using a neural network so as to predict an ablation rate of a next pulse or next cycle time according to the input ablation rate change. With the laser focus position as a controlled object, and the actual ablation rate change as the output, the drilling depth is measured in real time through an interferometric measurement system and converted into a real-time ablation rate change as feedback, and the laser ablation rate change is always positive or unchanged by adjusting the focus position in real time. Based on the above ideas, combined with a model prediction control method, a laser drilling high-speed processing control model is established so as to realize high-efficiency drilling.

A light field distribution of laser processing is adjusted with a hole depth control as a target by using a quantitative removal processing strategy when the current hole processing stage is the early penetration stage and the hole forming stage. A conventional Gaussian laser distribution with hyperbolic transmission characteristics is adjusted to a Bessel-like beam distribution with limited axial transmission, which realizes trimming of the hole without a protective material and ensures that the processing depth is as constant as possible, avoiding damage to a back wall.

The current hole processing stage is the hole completion stage, and the processing process is stopped.

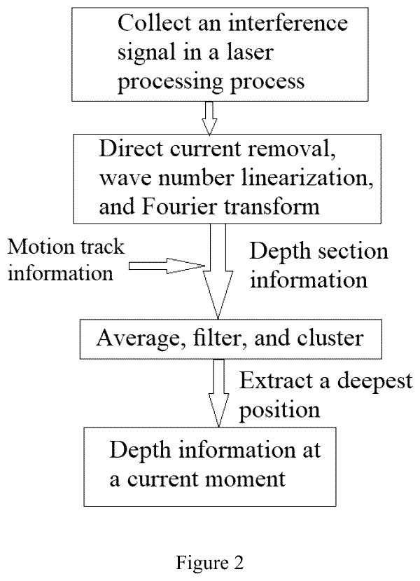

Specifically, as shown in FIG. 2, in step 1, a specific method flow for obtaining the current hole depth in the processing process in real time by using the sensing system is as follows.

S101, an interference signal in the laser drilling process is collected in real time by using a spectrometer in the interferometric measurement system.

S102, the interference signal is processed to obtain depth information, wherein:

the interference signal obtained in S101 is preprocessed sequentially by using direct current removal and wave number linearization, and the preprocessed interference signal is obtained.

Afterwards, the preprocessed interference signal is demodulated by using Fourier transform to obtain the depth information of each point in a Z direction.

S103, combining the motion track information, considering effects of debris, plasma cruption and hole shape evolution on data collection in the processing process, noise reduction processing is performed on the depth information recovered from the interference signal collected at the same position point, the depth information obtained by scanning a plurality of time frames is averaged, the depth information is further filtered to reduce noise points, remaining depth points are then clustered and segmented to extract the depth information in the processing process, a maximum value of the depth information is extracted, and its depth maximum value is used as the current hole depth.

In step 2, according to the obtained depth information and motion track information, the reconstruction of the three-dimensional shape of the hole is realized, and the depth features and shape features are extracted. A specific method flow is as follows.

S601, a position comparison output function of a motion controller is used. When a motion axis or a galvanometer axis reaches a specific position, the motion controller outputs a signal to trigger an interferometric sensing system, and the current hole depth information is collected in real time, so as to obtain processing point planar coordinates (x, y) and the depth information z in real time, i.e., three-dimensional coordinate point cloud data (x, y, z).

S602, the point cloud obtained in the processing process is processed. The noise points are removed by point cloud filtering, and the point cloud data is segmented according to the similarity of the point cloud. The point cloud data is further fitted into a plane by a fitting algorithm, and the point cloud is reconstructed into a three-dimensional model by establishing a three-dimensional topological relationship of the point cloud data, realizing real-time reconstruction of the three-dimensional shape in the drilling process.

S603, key features of the hole shape in laser drilling are considered, such as a hole inlet diameter, a hole outlet diameter, and a hole roundness, and the above shape features are extracted based on the reconstructed three-dimensional model.

In step 3, different drilling strategies are used according to different drilling stages, and the specific drilling strategies are as follows.

S701, sensor signals in the laser drilling process are collected in real time, and the drilling stage is identified according to the state identification model.

S702, when the laser processing process is at the unpenetrated stage, a high-speed processing strategy is used, that is, a current drilling depth, laser power, a focus position, etc. are used as inputs, and a correlation model between the ablation rate change and the current drilling depth, the laser power and the focus position is established by using a neural network, so as to predict an ablation rate of a next pulse or next cycle time according to the input ablation rate change. With the laser focus position as a controlled object, and the actual ablation rate change as the output, the drilling depth is measured in real time through an interferometric measurement system and converted into a real-time ablation rate change as feedback, and the laser ablation rate change is always positive or unchanged by adjusting the focus position in real time. Based on the above ideas, combined with a model prediction control method, a laser drilling high-speed processing control model is established so as to realize high-efficiency drilling.

S703, the processing strategy is switched to a quantitative removal processing strategy when the laser processing process is converted from the unpenetrated stage to the early penetration stage. That is, processing point coordinates are located through coaxial vision, and a Gaussian processing light path is switched to a beam shaping light path. A hole is trimmed by using the shaped beam. At the same time, the processing depth is measured in real time by using the interferometric sensing system to ensure high-quality processing without damage to a wall.

S704, when the laser processing process is at the hole completion stage, processing is stopped.

In step 3, a specific method for obtaining the parameters of the current processing stage is as follows.

S31, signal evolution information, a current hole depth, and motion track information in a laser drilling processing process are obtained.

S32, sequential eigenvalues are obtained according to the signal evolution information; and the current hole depth and the motion track information are combined to obtain the three-dimensional point cloud model.

S33, the shape features of the hole are extracted by using the three-dimensional point cloud model, and the shape features of the hole, the hole depth, and the sequential eigenvalue values are the parameters of the current processing stage.

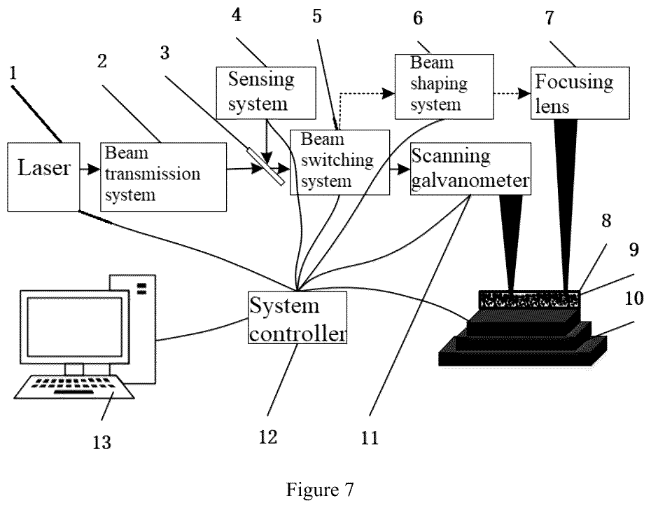

As shown in FIG. 7, in step 3, a specific method for adjusting the conventional Gaussian laser distribution with hyperbolic transmission characteristics to the Bessel-like beam distribution with limited axial transmission is as follows.

S301, a laser processing system and a camera are calibrated. A multi-axis motion stage coordinate system in the laser processing system is known. The camera is used to collect position information of different points on a motion stage, so that a relationship model corresponding to any point of pixels on an image in the camera and processing coordinates may be obtained, and solving the relationship model may establish a conversion model between the motion stage coordinate system and a camera coordinate system.

Similarly, in combination with the motion of the motion stage, the laser performs processing at different positions, the camera is used to obtain the coordinates corresponding to the processing position, so that a correlation model between a laser pose and the camera coordinate system may be established, and thus the conversion model among the three coordinate systems may be obtained.

S302, the camera is used to collect an image of a processing region, pre-processing operations such as enhancement and filtering are performed on the image, and a circular center coordinate position of the hole in a processing region is extracted and converted to multi-axis motion stage coordinates.

S303, the beam switching system is used to convert the Gaussian beam transmission light path to the beam shaping light path, a difference between a laser pose of the Gaussian beam transmission light path and a laser pose of the beam shaping light path is considered and converted into a difference between position coordinates of the multi-axis motion stage, and the multi-axis motion stage is used to move the workpiece so as to make a circular center of the processing region coincide with a center of the laser focus position of the beam shaping light path, thus further trimming the hole.

A specific shaping principle of the beam shaping light path is as follows.

S3031, a phase distribution of the Gaussian beam shaped into the axial-ablation-limited Bessel-like beam is calculated by using an analytical method, e.g., the corresponding phase distribution is calculated according to the following formula:

$$φ ( r ) = - \frac{{R}^{2} ( {Z}_{1} + {Z}_{2} )}{2 {Z}_{2}^{2}} \times ln [ \frac{{Z}_{1} {Z}_{2}}{{Z}_{1} + {Z}_{2}} + \frac{{Z}_{2}^{2}}{{R}^{2} ( {Z}_{1} + {Z}_{2} )} {r}^{2} ]$$

where R is a diffraction plane right angle, and Z1 and Z2 are a start point and an end point of the beam respectively.

S3032, the phase distribution is used to be input to a spatial light modulator or to make a corresponding diffraction optical element to realize the control of the beam axial distribution, which is combined with a 4f system to limit its focal depth to a specific region to meet processing requirements.

In step 1, the target material may be a material with a hollow cavity such as an engine blade, and an oil nozzle.

In step 1, the sensing system mainly includes an interferometric measurement system, a camera, a photodiode, etc., wherein the interferometric measurement system may measure the depth of the hole, the camera may be a black-and-white camera, a color camera, or a thermal imaging camera, etc., and the photodiode may be replaced with an instrument such as a spectrometer.

In step 1, the motion track information mainly refers to the coordinates of the position at which the current multi-axis motion stage is located, which may be obtained by grating feedback or reading by a system controller.

In step S302, extracting the circular center position of the hole in the processing region is mainly completed by using an edge extraction and a template matching method.

As shown in FIG. 7, a protective system combining process monitoring and control in laser drilling provided by the present disclosure includes a laser 1, a beam transmission system 2, a dichroic mirror 3, a sensing system 4, a beam switching system 5, a beam shaping system 6, a focusing lens 7, a multi-axis motion stage 10, a scanning galvanometer 11, a system controller 12, and an industrial control computer 13. A laser beam output by the laser 1 passes through the beam transmission system 2 and is then incident through the dichroic mirror 3 to the beam switching system 5. An output light path of the beam switching system 5 is divided into two paths, one of which passes through the beam shaping system 6 and is then incident to the focusing lens 7 for focusing, and the other is incident to the scanning galvanometer 11 for focusing. Laser beams output by the focusing lens 7 and the scanning galvanometer 11 act on a target material 8 on the multi-axis motion stage 10.

The beam switching system 5 is used for controlling switching of the laser transmission light path.

The beam shaping system 6 is used for adjusting a longitudinal energy distribution of a Gaussian beam to control an ablation depth within a certain range.

The system controller 12 is connected to the sensing system 4, the laser 1, the beam switching system 5, the scanning galvanometer 11 and the multi-axis motion stage 10, and is used for processing a signal collected by the sensing system, for feeding back a processing state, and for a collaborative control of the multi-axis motion stage, the scanning galvanometer, the laser, etc.

The industrial control computer 13 is connected to the system controller 12 and is used for controlling a command logic of the system controller.

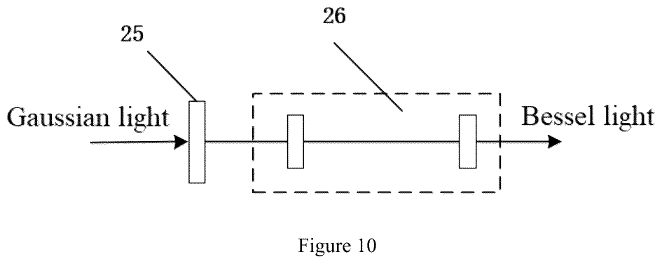

As shown in FIG. 10, the beam shaping system 6 includes a beam shaping element 25 and a 4f system 26, wherein the beam shaping element 25 is a spatial light modulator, a diffraction optical element, a conical lens, or an ultra-surface element. Gaussian light is incident through the beam shaping element 25 to the 4f system 26 to form Bessel light.

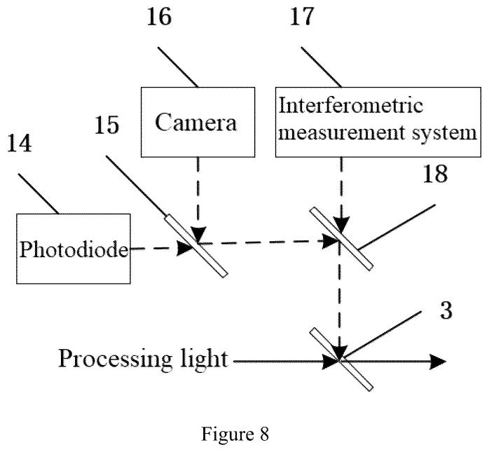

As shown in FIG. 8, the sensing system 4 includes a photodiode 14, a camera 16, and an interferometric measurement system 17, wherein the photodiode 14 is placed on the back of a target material and is used for calibrating a laser drilling stage, and the photodiode 14 is placed coaxially with the camera 16 through a beam splitter 15, and is used for monitoring a sequential change process of plasma radiation signals in the drilling process. The camera is coaxially coupled to the interferometric measurement system 17 through the dichroic mirror 18 and is used for monitoring a spatial distribution of surface optical radiation signals and for localization in the drilling process, and the interferometric measurement system 17 is coupled to processing light through the dichroic mirror 3 and is used for measuring the hole depth in the drilling process.

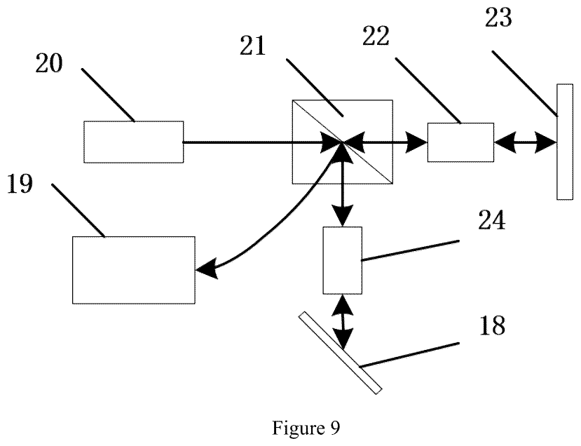

As shown in FIG. 9, the interferometric measurement system 17 includes a detection light source 20, a collimator 122, a beam splitter 21, a collimator 224, and a signal detector 19, wherein the detection light source 20 emits a detection beam which is then incident to the beam splitter 21. The beam splitter 21 splits one beam of light into two beams of light, one of which passes through the collimator 122 and is then incident onto a reference mirror 23, and the other beam of light passes through the collimator 224 and the dichroic mirror 18 to be coupled with the processing beam and focused onto the target material. Sample light reflected back from the target material interferes with reference light reflected back from the reference mirror 23 back into the beam splitter 21 and is further incident onto the signal detector 19. The signal detector 19 is used for obtaining an interference spectrum signal resulting from the interference of the sample light with the reference light.

The detection light source 20 is an ultra-radiant light emitting diode, a sweep frequency laser light source, a fiber laser or a semiconductor laser.

The signal detector 19 is a photodiode, a spectrometer or a balance detector.

Although laser, beam switching system, beam transmission system, beam shaping system, dichroic mirror, sensing system, scanning galvanometer, focusing lens, target material, multi-axis motion stage, system controller, industrial control computer, interferometric sensing system, photodiode, camera, detection source, collimator, beam splitter, signal detector, state identification model, high-speed processing strategy, quantitative removal processing strategy, etc. are used more frequently in this specification, the possibility of using other terms is not excluded, these terms are used only for the purpose of more conveniently describing the nature of the present disclosure, and interpreting them as any kind of additional limitation is contrary to the spirit of the present disclosure.

### Embodiment 1: No Filler Material

Laser processing of a blade air film cooling hole is taken as an example, with a single crystal high-temperature alloy blade as a target material, and a cavity thickness 0.5 mm-3 mm, mainly contains the following steps.

Step 1, processing parameters are determined according to a hole processing diameter, depth, and tilt angle, a blade is processed, and a sensing system obtains parameters of a current processing stage in real time.

Step 2, an autoregressive deep learning method is used to establish a prediction model of penetration time according to a calibrated laser drilling stage and information such as sequential eigenvalues and laser processing parameters in the obtained processing stage parameters, and the obtained hole depth features, shape features and sequential eigenvalue values are combined, and a machine learning method is used to establish a drilling stage identification model by using hole shape features and sequential features corresponding to the calibrated different drilling stages. Identification result confidence output from the drilling stage identification model at different moments are weighted to obtain synthesized confidence of identification results at the current moment, and prediction results of the prediction model of penetration time are fused to form a state identification model for the laser drilling stage.

Step 3, parameters of the current processing stage are obtained in real time in the laser drilling process, and the relevant parameters are input into the established state identification model, and the state identification model is used to identify the current drilling stage. The high-speed processing strategy is used in an unpenetrated stage, and a focus position is adjusted in real time to perform high-speed processing according to the measured hole depth and ablation rate. The drilling strategy is adjusted to a quantitative removal processing strategy after identifying that the drilling stage enters an early penetration stage.

Step 4, processing point coordinates are located by coaxial vision, a Gaussian processing light path is switched to a beam shaping light path, the processing light path is switched to the beam shaping system by using a beam switching system, a coaxial camera is used to identify drilling circular center coordinates, and the processed workpiece is moved to the position of the beam shaping processing light path based on an established conversion model of camera, motion stage, and laser position coordinate systems. At this time, the hole is trimmed by using shaped Bessel light, and the drilling depth is monitored in real time to ensure that it does not exceed a sum of the drilling depth and the cavity thickness. Processing is stopped when the laser drilling stage is monitored to reach a hole completion stage.

### Comparative Example 1: With a Filler Material

Laser processing of a blade air film cooling hole is taken as an example, ceramic particles with a diameter of 50 μm-200 μm being used as a protective material, a single crystal high-temperature alloy blade being used as a target material, with a cavity thickness 0.5 mm-3 mm, and mainly includes the following steps.

Step1, the ceramic particles of a corresponding diameter are selected to fill a blade cavity according to the cavity thickness.

Step 2, processing parameters are determined according to a hole processing diameter, depth, and tilt angle, a blade is processed, and a sensing system obtains parameters of a current processing stage in real time.

Step 3, an autoregressive deep learning method is used to establish a prediction model of penetration time according to a calibrated laser drilling stage and information such as sequential eigenvalues and laser processing parameters in the obtained processing stage parameters, and the obtained hole depth features, shape features and sequential eigenvalue values are combined, and a machine learning method is used to establish a drilling stage identification model by using hole shape features and sequential features corresponding to the calibrated different drilling stages. Identification result confidence output from the drilling stage identification model at different moments are weighted to obtain synthesized confidence of identification results at the current moment, and prediction results of the prediction model of penetration time are fused to form a state identification model for the laser drilling stage.

Step 4, parameters of the current processing stage are obtained in real time in the laser drilling process, and the relevant parameters are input into the established state identification model, and the state identification model is used to identify the current drilling stage. The high-speed processing strategy is used in an unpenetrated stage, and a focus position is adjusted in real time to perform high-speed processing according to the measured hole depth and ablation rate. The drilling strategy is adjusted to a quantitative removal processing strategy after identifying that the drilling stage enters an early penetration stage.

Step 5, processing point coordinates are located by coaxial vision, a Gaussian processing light path is switched to a beam shaping light path, the processing light path is switched to the beam shaping system by using a beam switching system, a coaxial camera is used to identify drilling circular center coordinates, and the processed workpiece is moved to the position of the beam shaping processing light path based on an established conversion model of camera, motion stage, and laser position coordinate systems. At this time, the hole is trimmed by using shaped Bessel light, and the drilling depth is monitored in real time to ensure that it does not exceed a sum of the drilling depth and the cavity thickness. Processing is stopped when the laser drilling stage is monitored to reach a hole completion stage.

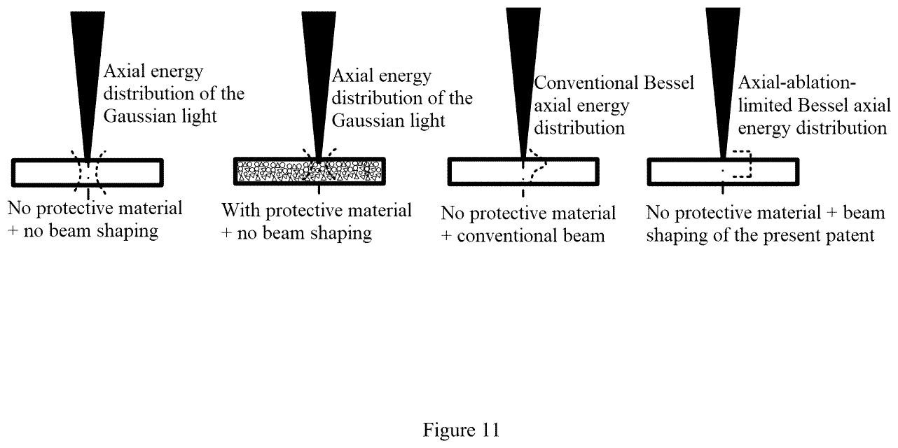

Beam shaping features of the present patent are further described in conjunction with FIG. 11.

A processing laser is generally in a Gaussian light distribution in the processing process, and its transmission in an axial direction is hyperbolic-like transmission, which gives the laser a contactless processing characteristic. However, when the laser processes a material with a hollow cavity, it continues to be transmitted to an inner wall of the cavity as it penetrates a surface material, causing damage to the inner wall of the cavity, as shown in the first drawing in FIG. 11, where it is extremely prone to cause damage to the inner wall of the cavity in the absence of a protective material and in the absence of beam shaping.

In order to solve this problem, filling of a protective material is currently the conventional means used by the industry. The cavity is filled with the protective material to attenuate or even eliminate laser energy, as shown in the second drawing in FIG. 11. Since it does not change an ablation characteristic of the laser itself, it can still cause damage to the protective material, and when laser irradiation time is too long or the cavity is too narrow, damage may still be caused to the inner wall of the cavity.

Therefore, based on an axial beam shaping control principle, the present patent controls an axial energy distribution of the laser so as to change the energy distribution of its axial transmission in space and realize the controllable axial ablation depth of the laser. The conventional Bessel beam has a characteristic of long focal depth, but at the same time its energy outside the focal depth is also limited. An axial energy distribution of the Bessel beam is shown in the third drawing in FIG. 11. However, its energy utilization is low, and a beam transmission range is long. It is difficult to realize wall-damage-free processing of a narrow cavity without a protective material. Therefore, on this basis, the beam is further shaped and axially controlled to become an axial-ablation-limited Bessel beam, as shown in the fourth drawing in FIG. 11, which makes it possible to realize trimming of different positions without damaging a back wall by controlling laser feed, and may ensure wall-damage-free processing in the narrow cavity.

What is claimed is:

1. A protective method combining process monitoring and control in laser drilling, comprising the following steps:
step 1, collecting signal evolution information, a current hole depth, and motion track information in a laser drilling processing process;
step 2, performing a feature extraction on the signal evolution information obtained in step 1 to obtain sequential eigenvalues evolving over time, and constructing a prediction model of penetration time according to the obtained sequential eigenvalues;
step 3, combining the current hole depth and the motion track information obtained in step 1 with the sequential eigenvalues to construct and obtain a drilling stage identification model;
step 4, synthesizing a prediction result of the prediction model of penetration time and combining identification result confidence of the drilling stage identification model at different moments to construct and obtain a state identification model; and
step 5, judging a current drilling processing stage according to the obtained state identification model, controlling the laser processing process according to a judgment result, and using different drilling strategies at different drilling stages.

2. The protective method combining process monitoring and control in the laser drilling according to claim 1, wherein in step 2, a specific method for constructing the prediction model of penetration time according to the obtained sequential eigenvalues is:
setting the drilling processing process in four stages, which are an unpenetrated stage, an early penetration stage, a hole forming stage, and a hole completion stage respectively;
obtaining remaining drilling penetration time values corresponding to sequential eigenvalues at different moments according to an evolution process of the set unpenetrated stage and early penetration stage; and
combining the obtained sequential eigenvalues with a laser parameter and a material parameter as training features, and using the remaining drilling penetration time values as training labels to construct and obtain the prediction model of penetration time by using an autoregressive deep learning method.

3. The protective method combining process monitoring and control in the laser drilling according to claim 1, wherein in step 3, a specific method for combining the current hole depth and the motion track information obtained in step 1 with the sequential eigenvalues to construct and obtain the drilling stage identification model is:
fusing the current hole depth and the motion track information obtained in step 1 to obtain depth information of a specific point on a drilling track;
forming three-dimensional point cloud information according to the obtained depth information;
filtering, segmenting and fitting the obtained three-dimensional point cloud information sequentially to obtain a three-dimensional point cloud model of a hole;
performing a feature extraction on the three-dimensional point cloud model of the hole to obtain shape features such as outlet and inlet diameters of the hole; and
combining depth features, the shape features and the sequential eigenvalues of the hole, and using the depth features and the shape features of the hole corresponding to calibrated different drilling stages as labels to construct and obtain the drilling stage identification model by using a machine learning method.

4. The protective method combining process monitoring and control in the laser drilling according to claim 1, wherein in step 4, a specific combination method for constructing and obtaining the state identification model according to a combination of the prediction model of penetration time and the drilling stage identification model is:
inputting the sequential eigenvalues and shape features corresponding to different moments into the drilling stage identification model established in step 3 so as to obtain the identification result confidence of drilling stages at different moments in real time;
inputting the sequential eigenvalues corresponding to different moments into the prediction model of penetration time established in step 2 so as to predict remaining penetration time corresponding to a current moment in real time;
weighing and fusing the identification result confidence of the drilling stages at different moments to obtain synthesized confidence at the current moment; and
performing a probability fusion on the predicted remaining penetration time at the current moment with the synthesized confidence to obtain the state identification model.

5. The protective method combining process monitoring and control in the laser drilling according to claim 1, wherein in step 5, the different drilling strategies are specifically:
adjusting a processing parameter with processing efficiency as a target when the current hole processing stage is an unpenetrated stage;
adjusting a light field distribution of laser processing with a hole depth control as a target when the current hole processing stage is an early penetration stage and a hole forming stage; and
stopping processing when the drilling stage switches from the hole forming stage to a hole completion stage.

6. The protective method combining process monitoring and control in the laser drilling according to claim 1, wherein a specific method for adjusting a processing parameter with processing efficiency as a target when the current hole processing stage is an unpenetrated stage is:
using a current drilling depth, laser power and a focus position as inputs, and an actual ablation rate change as an output; and establishing a correlation model between the ablation rate change and the current drilling depth, the laser power and the focus position by using a neural network, and adjusting the processing parameter by using the correlation model.

7. The protective method combining process monitoring and control in the laser drilling according to claim 5, wherein a specific method for adjusting the light field distribution of laser processing with the hole depth control as the target when the current hole processing stage is the early penetration stage and the hole forming stage is:
locating processing point coordinates through coaxial vision, and switching a Gaussian processing light path to a beam shaping light path;
shaping a Gaussian beam into an axial-ablation-limited Bessel beam by using a beam shaping device; and
trimming a hole by using the shaped beam.

8. A protective system combining process monitoring and control in laser drilling, comprising a laser (1), a beam transmission system (2), a dichroic mirror (3), a sensing system (4), a beam switching system (5), a beam shaping system (6), a focusing lens (7), and a scanning galvanometer (11), wherein a laser beam output by the laser (1) passes through the beam transmission system (2) and is then incident through the dichroic mirror (3) to the beam switching system (5); an output light path of the beam switching system (5) is divided into two paths, one of which passes through the beam shaping system (6) and is then incident to the focusing lens (7) for focusing, and the other is incident to the scanning galvanometer (11) for focusing; and laser beams output by the focusing lens (7) and the scanning galvanometer (11) act on a target material (8).

9. The protective system combining process monitoring and control in laser drilling according to claim 8, wherein the beam shaping system (6) comprises a beam shaping element (25) and a 4f system (26), wherein the output light path of the beam switching system (5) passes through the beam shaping element (25) and is incident to the 4f system (26) to form Bessel light.
